(19) United States
(12) Patent Application Publication
(10) Pub. No.: US 2024/0149720 A1
(43) Pub. Date: May 9, 2024

(54) METHOD FOR OPERATING A CHARGING STATION DESIGNED AND PROVIDED FOR CHARGING A TRACTION BATTERY OF A MOTOR VEHICLE WITH ELECTRIC ENERGY, AND THE CORRESPONDING CHARGING STATION

(71) Applicant: AUDI AG, Ingolstadt (DE)

(72) Inventors: Matthias SCHNEIDER, Schernfeld (DE); Stefan WALTL, Reichertshofen (DE)

(21) Appl. No.: 18/499,966

(22) Filed: Nov. 1, 2023

(30) Foreign Application Priority Data
Nov. 4, 2022 (DE) 102022129146.4

(51) Int. Cl. B60L 53/30

(52) U.S. Cl. CPC B60L 53/305; B60L 2250/16; B60L 2250/22

(57) ABSTRACT

A method for operating a charging station designed and provided for charging a traction battery of a motor vehicle with electric energy, wherein the charging station comprises a display device for displaying information and an operating device for receiving a manual input of a user. The display device and the operating device are relocated at least temporarily in relation to a housing of the charging station. A charging station for charging a traction battery of a motor vehicle with electric energy is also provided.

### BACKGROUND

### Technical Field

The present disclosure relates to a method for operating a charging station designed and provided for charging a traction battery of a motor vehicle with electric energy, wherein the charging station comprises a display device for displaying information and an operating device for receiving a manual input of a user. A charging station for charging a traction battery of a motor vehicle with electric energy is also provided.

### Description of the Related Art

From the prior art there is known, for example, the publication DE 10 2020 102 518 A1. This describes a charging column which is suitable for and provided for the charging of electric vehicles, having a housing, a power and HMI unit, wherein the power and HMI unit comprises a display and operating device, wherein the display and operating device comprises display and/or control elements, which are arranged on the front side of the housing of the charging column, and an energy conversion unit, the energy conversion unit comprising a device for the conversion of a liquid and/or gaseous energy carrier into electric energy. It is provided that the power and HMI unit is arranged between the front side of the housing and the energy conversion unit.

Furthermore, a method is known from publication EP 1 368 788 B1 serving for the tracking of an object of interest which is being controlled by a user, in order to communicate with a computer. The method involves the following: the registering of images of an object of interest within a region of interest by at least two observation points; processing of the registered images in order to produce an image data set for each image so registered; generating a background data set from each image data set; comparing each image data set with its corresponding background data set in order to produce a difference mapping for each image so registered; determining a relative position of the object of interest within each difference mapping; producing the absolute position of the object of interest within the region of interest from the relative positions of the object of interest within each difference mapping; and use of the absolute position to allow the user to communicate with a computer application.

### BRIEF SUMMARY

Some embodiments provide a method for operating a charging station designed and provided for charging a traction battery of a motor vehicle with electric energy which has advantages over known methods, such as making possible a comfortable and reliable use of the charging station.

The method described herein serves for operating the charging station. The charging station is designed and intended or adapted to charging the traction battery of the motor vehicle with electric energy. For this, the charging station produces an electrical connection between the charging station and the traction battery. The charging station can be designed and provided, for example, for the conductive and/or inductive transmission of the electrical energy.

In some embodiments, the charging station may include a parking place for the motor vehicle, on which the user of the charging station positions the motor vehicle. For example, by the positioning of the motor vehicle on the parking place there is already produced the electrical connection between the charging station and the motor vehicle or its traction battery. This is the case in particular for an at least partial inductive energy transmission between the charging station and the motor vehicle. It can, however, also be provided that after the parking of the motor vehicle on the parking place a conductive electrical connection will be produced between the charging station and the motor vehicle. For this, a charging cable will be used, for example, which electrically connects the charging station to the motor vehicle or the traction battery.

The charging cable may be firmly connected to the charging station and after the parking of the motor vehicle, it is connected to the latter. However, the charging cable on the one hand may be hooked up to the charging station and on the other hand to the motor vehicle after the motor vehicle has been parked on the parking space. The hooking up of the charging cable can be done by the user himself or by a suitable mechanism. The latter, in some embodiments, provides for an automatic hooking up of the charging cables at least to the motor vehicle.

The charging station possesses the display device and the operating device. The display device is designed and provided for the displaying of the information, the operating device for the receiving of the manual input of the user. Using the display device, the charging station thus presents the user with information at least for a certain time. For example, the information may be status information of the charging station. The display device shows the information in text form and/or graphically. In some embodiments, the display device has a monitor screen or is outfitted as such. The monitor screen may be a LCD, LED or OLED monitor screen.

With the aid of the operating device, the user makes use of the charging station, for example, he sets the charging station to start a charging process or to end the charging process. In particular, he sets one or more charging parameters for the charging station to be used during the charging process, for example, a charging current to be used for the charging, the quantity of current to be supplied to the traction battery and/or a target state of charge which the traction battery should have after the charging. In addition or alternatively, he initiates a payment process through the operating device and/or carries this out. By the charging process is to be understood a process during which the charging station acts upon the traction battery for its charging with the electrical energy. Outside of the charging process the traction battery is not supplied with electric energy by the charging station, and in some embodiments the electrical connection between the charging station and the traction battery is broken outside of the charging process.

The operating device comprises, for example, at least one button and/or at least one touch screen. In the latter instance, the operating device and the display device are integrated in design with each other, so that the touch screen is composed of the monitor screen of the display device and a detection device of the operating device, the latter detecting the manual input of the user. Both the display device and the operating device are arranged on the outside of a housing of the charging station, namely, such that they are facing an outside environment or the surroundings of the housing and are accessible to the user from the outside environment or the surroundings.

In order to enable a fast, precise, and convenient way of viewing the information and performing the manual input, regardless of the stature and/or condition of the user, the display device and the operating device may be relocated with respect to the housing of the charging station, such as in a motorized manner. This means that the display device and the operating device are mounted movably on the housing, so that they can be relocated from a first position in the direction of a second position or as far as the second position and then back.

The relocating of the display device and the operating device can be done manually, i.e., by the user grasping the display device and the operating device. For this, the display device and the operating device are mounted movably with respect to the housing, in particular they are mounted movably on the housing. In some embodiments, however, a motorized driving of the display device of the operating device is provided. For this purpose, a drive unit is present, by which the display device and the operating device are relocatable or at least relocated temporarily.

For example, a distinction is drawn between a mounting and a drive unit for the display device and the operating device. The mounting of the display device and the operating device with respect to the housing or on the housing can be realized, for example, by a cable, a belt, a rail, and/or a chain. The cable and the chain may be mounted on at least two wheels rotatably mounted and spaced apart from each other, such as rollers, gears, or sprockets, and the display device and the operating device are fastened to the cable or the chain, so that upon rotation of the cable or the chain a relocating of the display device and the operating device occurs.

The mounting moves the display device and the operating device in linear manner, i.e., along an imaginary, straight line. For example, the mounting may be configured such or the relocating occurs such that the display device and the operating device may be relocated or are relocated along an axis, i.e., along the straight line, such as in this manner. The display device and the operating device may be relocated in multiple dimensions with respect to the housing, for example, along or on an imaginary plane. In some embodiments, the drive unit may be an electric motor, such as a rotation motor or a linear motor.

The display device and the operating device may be relocatable within a region or are relocated in a region of such size that all the standards and directives for fulfilling a freedom from barriers are satisfied, such as are defined, for example, in DIN 18040-1 of October 2010 (DIN 18040-1:2010-10). This means that the display device and/or the operating device should be at least relocatable such that in a first position their respective lower edge is situated at most 100 cm, at most 90 cm, at most 85 cm, at most 80 cm or at most 75 cm above the ground on which the charging station is situated. In a second position, on the other hand, a lower edge of the display device and/or the operating device may be more than 100 cm, at least 110 cm, at least 120 cm, at least 130 cm, at least 140 cm or at least 150 cm above the ground. In this way, on the one hand, a freedom from barriers can be assured for the charging station and on the other hand a convenient use is assured for the user.

In some embodiments, the relocating may be done for a height adjustment of the display device and/or the operating device, such as for these devices. Consequently, by the relocation the height of the display device or the operating device is changed, i.e., the distance between the ground on the one hand and the display device or the operating device on the other hand. The critical point here is once again the respective lower edge of the display device or the operating device, for example.

The display device and/or the operating device can be relocated with respect to the charging station such that the height adjustment is only possible by the relocating. However, a sideways relocating of the display device and/or the operating device may be done at least temporarily in addition, or alternatively, to the height adjustment or the display device and/or the operating device are mounted for such a sideways relocating with respect to the housing and/or on the housing of the charging station. The described procedure allows a flexible adjustment of the display device or the operating device and a convenient use of the charging station.

In some embodiments, a target position of the display device and/or a target position of the operating device may be determined and an actual position may be adjusted to the respective target position by the relocating. In other words, the target position of the display device is determined and the actual position of the display device is adjusted to the determined target position. In addition or alternatively, the target position of the operating device may be determined and the actual position of the operating device may be adjusted to the determined target position.

For example, the charging station has a controller, which undertakes the determining of the target position of the display device and/or the target position of the operating device. The respective target position may be determined in any manner desired. Once the target position has been determined, the display device, the operating device, or both will be relocated with respect to the housing, so that their respective actual position is changed in the direction of the respective target position, in particular, until the respective actual position corresponds to the respective target position. For this, the controller is connected to the drive unit, for example, and actuates it. The described procedure again makes possible an adjusting of the charging station for a convenient and comfortable use by the user.

In some embodiments, at least one of the target positions may be determined with the aid of a feedback value of a control element of the charging station and/or with the aid of a feedback value of a sensor device of the charging station. Insofar as there is mention in the context of this specification of the target position, at least one of the target positions, or the target positions, the remarks can also be applied in equivalent manner. Thus, some embodiments can be provided to determine only the target position of the display device or only the target position of the operating device and to relocate the respective device such that its actual position corresponds to the determined target position.

However, a separate target position will be determined each time for both the display device and the operating device. These may stand in a fixed relationship to each other or they may be chosen independently of each other. In the first instance, the display device and the operating device are relocated together, in order to adjust their respective actual position to the corresponding target position. In the second instance, on the other hand, the display device and the operating device may be relocated independently of each other in order to adjust the respective actual position to the respective target position.

The target position is determined with the aid of the feedback value of the control element and/or with the aid of the feedback value of the sensor device. For example, heights for the operating device and the display device are used in this case, assuring a barrier-free access according to DIN 18040, EN 301 549, EN 17210 and/or EN 17161. These heights are, for example, between 85 cm and 125 cm in Germany and between 90 cm and 110 cm in Switzerland.

By the control element is to be understood an element different from the operating device and arranged separately from it, by which the user can perform a manual input. The control element is, for example, designed and provided and correspondingly arranged for manual activation or foot activation by the user. The control element serves for relocating of the display device and the operating device or specifying the respective target position for the charging station. The control element is present, for example, in the form of a button, a switch, a rocker switch, or the like, or it comprises at least one such element. However, it can also be present as a touch sensor or a touch screen.

The touch sensor is integrated in the housing, for example, or it forms part of a surface of the housing. In some embodiments, the surface of a major portion of the housing may be configured as a touch sensor, i.e., at least 50%, at least 75% or more. This means that the user can touch the housing in almost any place and the location of the touch will be detected. From this, the target position or the target positions will be determined. The display device and the input device may be relocated in the direction of the location of the touch, such as up to the location of the touch. The control element in any case makes possible a quick and efficient adjusting of the charging station by the user to the particular needs of the user.

In addition or alternatively, the target position may be determined with the aid of the feedback value of the sensor device. By the sensor device is to be understood in particular a surroundings monitoring device for monitoring the surroundings of the charging station. Thus, the sensor device monitors the surroundings of the charging station in order to ascertain at least one attribute of the user. The at least one attribute can be, for example, one or more of the following attributes: position relative to the charging station, body height, eye height, gripping height, sitting height. With the aid of the at least one attribute of the user, the at least one of the target positions is determined. This enables an automatic adjusting of the charging station to the needs of the user.

In some embodiments, the sensor device used may be a sensor device having a proximity sensor and/or an optical sensor. The proximity sensor is, for example, designed and provided to recognize an approach of the user to the charging station. In addition or alternatively, it serves for recognizing the body height of the user, or whether the user is availing himself of a mobility aid. By a mobility aid is understood, for example, a wheelchair, a walker, a cane or the like.

The optical sensor is present, for example, in the form of a sensor strip, such as a line sensor, in order to determine the body height of the user. However, it may also be configured as a camera, such as one having a CCD sensor. An image of the surroundings of the charging station taken by the camera is evaluated in order to ascertain the at least one attribute of the user, such as by the controller.

However, the determination can alternatively be done as well in an external device. In this case, the image taken by the camera is relayed to the external device. This determines, from the relayed image, the at least one attribute of the user and relays this in turn to the charging station or its controller. Machine learning and/or artificial intelligence may be used in the determining of the at least one attribute of the user, regardless of where it is done. The described procedure makes possible an optimal adjusting of the display devices and/or the operating device for each user and thus an excellent usage comfort of the charging station.

In some embodiments, the target position of the display device and/or the target position of the operating device may be set to a respective starting position after a certain lapse of time. Each time a starting position is dictated for the target position of the display device, for the target position of the operating device, or for both target positions. If the charging station ascertains that it has not been used any more after the particular lapse of time or no manual input of the user has been done after the particular lapse of time, the target position will be set to the starting position.

The starting position is chosen, for example, for the best possible accessibility, i.e., to achieve a barrier-free access to the charging station. According to DIN 18040-1, the starting position is chosen such that the display device and the operating device are arranged with their lower edge at most 80 cm, at most 85 cm or at most 90 cm above the ground. Of course, a different starting position may also be chosen. The described procedure, in turn, makes possible the good usage comfort of the charging station.

In some embodiments, the display device and the operating device may be relocated at least temporarily independently of each other. While it can also be provided, of course, that the relocating of the display device and the operating device will occur coupled with each other or that the display device and the operating device are firmly joined together and are relocated together, an independent relocating can also be realized. This makes it possible to adjust the display device and the operating device optimally to the needs of the user or to arrange them accordingly. Preferably, the target positions of the display device and the operating device in this case are each determined from the at least one attribute of the user, in particular by different computational procedures. In this way, an especially good usage comfort of the charging station can be achieved.

In some embodiments, the feedback value of the sensor device may be used to determine the eye height of the user and the target position of the display device may be determined with the aid of the eye height, and/or for feedback value of the sensor device may be used to determine the gripping height of the user and the target position of the operating device may be determined with the aid of the gripping height. Thus, the eye height may be used as the attribute of the user and for this may be determined with the aid of the sensor device or its feedback value.

By the eye height is to be understood in particular the distance of the eyes of the user from the ground. The target position of the display device is then determined from the eye height, for example, by a computation routine. For example, the target position of the display device is set equal to the eye height or the target position corresponds to the eye height minus a component of the height of the display device. For example, half of the display device is used in this case.

In addition or alternatively, the gripping height may be determined as the attribute of the user, namely, once again by the sensor device or its feedback value. The target position of the operating device is then determined with the aid of the gripping height. This occurs similar to the determining of the target position of the display device with the aid of the eye height, so that reference is made to the corresponding remarks. The described procedure makes possible a specially targeted adapting of the charging station to the user or to his physical attribute.

In some embodiments, the control element in addition may be relocated at least temporarily in relation to the housing of the charging station. The relocating of the control element in this case is done independently of the relocating of the display device and the operating device. For example, the control element takes up different positions in relation to the housing in certain time intervals, in order to be reached by persons with different physical attributes.

In some embodiments, the control element takes up a first position after a first lapse of time and a second position, different from the first position, after a second lapse of time, remaining constant during the respective lapse of time. Thus, the control element is periodically relocated back and forth between the two positions, in particular to allow users of different body height to easily reach the control element. Such as the relocating of the control element may be halted for as long as the control element is being operated by the user. This means that after the last operation of the control element by the user there is a waiting period for a certain lapse of time before the periodic relocating of the control element is commenced once more. In this way, good usage comfort is achieved.

Some embodiments provide a charging station for charging a traction battery of a motor vehicle with electric energy, wherein the charging station comprises a display device for displaying information and an operating device for receiving a manual input of a user. The charging station is designed and provided to relocate the display device and the operating device at least temporarily in relation to a housing of the charging station.

The benefits of such a configuration of the charging station or such a procedure have already been pointed out. Both the charging station and the method for its operation can be modified according to the remarks in the context of this specification, so that reference is made to those remarks accordingly.

The features and combinations of features described in the specification, especially the features and combinations of features described in the following description of the figures and/or shown in the figures, can be used not only in the particular combination indicated, but also in other combinations or standing alone, without leaving the scope of the present disclosure. Thus, embodiments not explicitly shown or explained in the specification and/or the figures, yet emerging from the explained embodiments or being derivable from them, are to be viewed as also encompassed by the present disclosure.

### BRIEF DESCRIPTION OF THE SEVERAL VIEWS OF THE DRAWINGS

The present disclosure is explained more closely in the following with the aid of the drawing.

FIG. 1 shows a schematic representation of a charging station for charging a traction battery of a motor vehicle as well as a user of the charging station.

### DETAILED DESCRIPTION

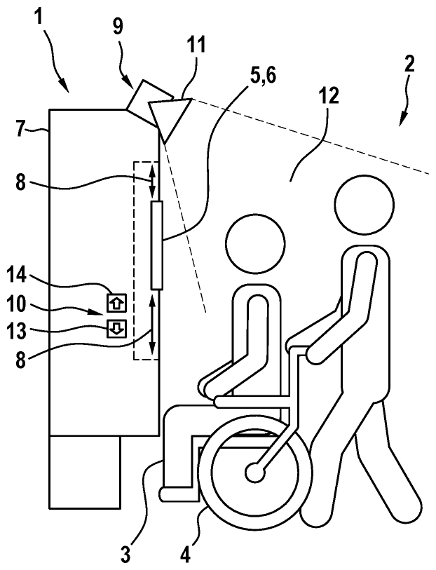

FIG. 1 shows a schematic representation of a charging station 1, which is designed and provided for the charging of a motor vehicle or a traction battery of the motor vehicle with electric energy. Also shown are the surroundings 2 of the charging station, in which a user 3 of the charging station 1 is present in the example shown. It can be seen that the user 3 is employing a mobility aid 4, for example, a wheelchair. Alternatively, a cane, a walker, or the like can be used as the mobility aid 4.

The charging station 1 comprises a display device 5 and an operating device 6, which are integrated with each other in the embodiment shown. Thus, the display device 5 and the operating device 6 together consist of a touch screen and a monitor screen with integrated input device. The display device 5, i.e., the monitor screen, serves for displaying information of the charging station 1. The operating device 6, on the other hand, is designed to receive a manual input of the user 3.

In order to make possible for the user 3 a convenient viewing of information presented by the display device 5 and a comfortable entering of input to the operating device 6, the display device 5 and the operating device 6 are relocatable with respect to a housing 7 of the charging station 1, in particular, they are mounted in relocatable manner on the housing 7. The relocating occurs in motorized manner, i.e., by a drive unit. The relocating of the display device 5 and the operating device 6 is shown by the double arrows 8. The relocating of the display device 5 and the operating device 6 occurs only for a height adjustment in the embodiment shown.

A target position of the display device 5 and a target position of the operating device 6 are ascertained in the embodiment by a sensor device 9 and/or a control element 10. The sensor device 9 comprises an optical sensor 11 or it is designed as such. The sensor 11 here is present as a camera. There is likewise indicated a visual field 12 of the optical sensor 11, which is pointed toward the surroundings 2 of the charging station 1, namely, such that it recognizes the user 3 and determines at least one physical attribute of the user 3.

From the physical attribute, the target positions are then determined and the display device 5 and the operating device 6 are relocated such that their respective actual position coincides with the corresponding target position. In addition or alternatively, the determining of the target positions can be done by using the control element 10. For this, the control element 10 is arranged to be conveniently reachable by the user 3. The embodiment shows a configuration of the control element 10 with two buttons 13,14, by which the target positions can be adjusted.

The described configuration of the charging station 1 enables a motorized relocating of the display device 5 and the operating device 6 such that the needs of the user 3 are satisfied. In particular, the display device 5 and the operating device 6 are relocated in motorized manner such that they are conveniently viewable and reachable by the user 3. Thus, greater usage comfort of the charging station 1 is achieved.

German patent application no. 10 2022 129146.4, filed Nov. 4, 2022, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for operating a charging station designed and provided for charging a traction battery of a motor vehicle with electric energy, wherein the charging station comprises a display device for displaying information and an operating device for receiving a manual input of a user, the method comprising:
relocating the display device and the operating device at least temporarily in relation to a housing of the charging station.

2. The method according to claim 1, wherein the relocating is done for a height adjustment of the display device and/or the operating device.

3. The method according to claim 1, wherein a target position of the display device and/or a target position of the operating device are determined and an actual position is adjusted to the respective target position by the relocating.

4. The method according to claim 3, wherein the target position is determined with the aid of a feedback value of a control element of the charging station and/or with the aid of a feedback value of a sensor device of the charging station.

5. The method according to claim 4, wherein the sensor device comprises a proximity sensor and/or an optical sensor.

6. The method according to claim 3, wherein the target position of the display device and/or the target position of the operating device are set to a respective starting position after a certain lapse of time.

7. The method according to claim 1, wherein the display device and the operating device are relocated at least temporarily independently of each other.

8. The method according to claim 4, wherein the feedback value of the sensor device is used to determine an eye height of the user and the target position of the display device is determined with the aid of the eye height, and/or the feedback value of the sensor device is used to determine a gripping height of the user and the target position of the operating device is determined with the aid of the gripping height.

9. The method according to claim 4, wherein the control element is relocated at least temporarily in relation to the housing of the charging station.

10. A charging station for charging a traction battery of a motor vehicle with electric energy, the charging station comprising:
a display device for displaying information; and
an operating device for receiving a manual input of a user,
wherein the charging station is configured to relocate the display device and the operating device at least temporarily in relation to a housing of the charging station.
